(19) United States
(12) Patent Application Publication
(10) Pub. No.: US 2019/0272361 A1
(43) Pub. Date: Sep. 5, 2019

(54) SYSTEM AND METHOD FOR CONTINUOUS AND COMPETITIVE AUTHENTICATION

(71) Applicant: Bank of America Corporation, Charlotte, NC (US)

(72) Inventors: Eren Kursun, New York, NY (US); Scott Anderson Sims, Tega Cay, SC (US); Dharmender Kumar Satija, Rye Brook, NY (US); David Eugene Swain, Los Angeles, CA (US); Kolt Arthur Bell, Charlotte, NC (US)

(21) Appl. No.: 15/908,959

(22) Filed: Mar. 1, 2018

(51) Int. Cl. G06F 21/32; G06F 21/31; H04L 9/32; H04L 29/06; G06F 17/30; H04L 29/08

(52) U.S. Cl. CPC G06F 21/32; G06F 21/316; H04L 9/3271; H04L 67/306; H04L 9/3215; H04L 63/0861; G06F 17/30702; H04L 9/3231

(57) ABSTRACT

The invention is a novel system that uses a continuous and competitive authentication process to identify users within an entity's systems. In particular, the invention may continuously collect authentication data across multiple channels (e.g., authentication data obtained through a mobile app, website, telephone, on-site methods, and the like) as well as non-authentication data. The obtained data may be compared with reference data (e.g., historical data) to continuously update a confidence level associated with the user. Based on the confidence level, profile the user to detect any inconsistencies in the data collected over time. The system may further execute one or more competitive processes in parallel with traditional authentication processes to identify potentially unauthorized users. In this way, the system provides not only a way to authenticate users, but also to create and build profiles of users who are suspected of being unauthorized and/or malicious users

### FIELD OF THE INVENTION

The present disclosure embraces a system, computer program product, and computer-implemented method for performing continuous and competitive biometric authentication. In particular, the system and method may provide a way to use partial or incomplete authentication data (e.g., biometric data) obtained across multiple channels to authenticate users and detect inconsistencies in the authentication data to identify unauthorized users. In this way, the system may perform competitive or adversarial authentication by proactively and strategically preventing unauthorized authentication attempts.

### BACKGROUND

In the data security context, the proliferation of online systems has created numerous technological challenges in identifying potentially unauthorized and/or malicious users. Accordingly, there is a need for a more secure way to authenticate users in online systems.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention is a novel system that uses a continuous and competitive biometric authentication process to identify users within an entity's systems. In particular, the invention may continuously collect authentication data across multiple channels (e.g., authentication data obtained through a mobile app, website, telephone, on-site methods, and the like). The obtained authentication data may be compared with reference data (e.g., historical data) to continuously update a confidence level associated with the user. Based on the confidence level, profile the user to detect any inconsistencies in the authentication data collected over time. The system may further execute one or more competitive processes to identify potentially unauthorized users. In this way, the system provides not only a way to authenticate users, but also to create and build profiles of users who are suspected of being unauthorized and/or malicious users.

Accordingly, embodiments of the present invention provide a system, a computer program product, and a computer-implemented method for continuous and competitive biometric authentication. The invention may comprise receiving a first set of authentication data from a user through a first channel, wherein the authentication data comprises biometric data; detecting that a confidence level associated with the user has dropped below a specified threshold; initiating a competitive authentication process; determining, based on a first mismatch vector, whether a first set of additional authentication data is required; determining system requirements for the first set of additional authentication data; determining strategy requirements for the first set of additional authentication data; and implementing the system requirements and the strategy requirements for the first set of additional authentication data.

In some embodiments, the invention may comprise receiving a second set of partial biometric data from the user through a second channel; determining, based on a second mismatch vector, whether a second set of additional authentication data is required; determining system requirements for the second set of additional authentication data; determining strategy requirements for the second set of additional authentication data; and implementing the system requirements and the strategy requirements for the second set of additional authentication data.

In some embodiments, determining whether a first set of additional authentication data is required comprises comparing the first set of authentication data with a user profile associated with the user, wherein the user profile associated with the user comprises historical biometric data associated with the user. The invention may further comprise, based on the first set of authentication data and the user profile associated with the user, determine whether to authenticate the user.

In some embodiments, the user profile is stored on a user profile database. The invention may further comprise continuously receiving biometric data associated with the user; and updating a user profile associated with the user to include the biometric data associated with the user.

In some embodiments, the user profile associated with the user further comprises non-biometric data, wherein the non-biometric data comprises behavioral, transactional, physiological, content data, application metadata, or device metadata and a location of the user.

In some embodiments, the invention may further comprise prompting the user for the first set of additional authentication data; receiving the first set of additional authentication data from the user; comparing the first set of additional authentication data with a user profile associated with the user; and determining, based on the first set of additional authentication data and the user profile associated with the user, that the user is an unauthorized user.

In some embodiments, the user profile database comprises one or more user profiles associated with known unauthorized users. Determining that the user is an unauthorized user may comprise comparing the first set of additional authentication data with a user profile associated with a known unauthorized user; and determining a match between the first set of additional authentication data with the user profile associated with the known unauthorized user.

In some embodiments, the invention further comprises detecting that a steady state has been reached for the first channel and the second channel; integrating the first set of authentication data and the second set of authentication data into a profile associated with the user; and determining, based on the profile associated with the user, whether a third set of additional authentication data is required.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram illustrating an operating environment for the continuous and competitive authentication system, in accordance with one embodiment of the present invention;

FIG. 2 is a block diagram illustrating the entity authentication server, the database server, and an authentication channel in more detail, in accordance with one embodiment of the present invention;

FIG. 3 is a process flow illustrating an application of the continuous and competitive online authentication process, in accordance with one embodiment of the present invention;

FIG. 4 is a process flow for calculating mismatch vectors to verify unauthorized access, in accordance with one embodiment of the present invention; and

FIG. 5 illustrates a process flow for a multi-channel and continuous authentication method, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices and/or systems on which the continuous and competitive authentication system described herein is implemented. The entity may be a business organization, a non-profit organization, a government organization, and the like.

“Entity system” or “authentication system” as used herein may refer to the computing systems and/or other resources used by the entity to collect authentication data and run the various processes needed to identify a user and/or inconsistencies in the collected authentication data.

“User” as used herein may refer to an individual who may attempt to log onto the entity's online system. In some embodiments, the user may be a client or prospective client of the entity who is authorized to access the online system. In other embodiments, the user may be an unauthorized and/or malicious individual who may attempt to assume a false identity.

“Computing system” or “computing device” as used herein may refer to a networked computing device within the entity system. The computing system may include a processor, a non-transitory storage medium, a communications device, and a display. The computing system may support user logins and inputs from any combination of similar or disparate devices. Accordingly, the computing system may be a portable electronic device such as a smartphone, tablet, single board computer, smart device, or laptop, or the computing system may be a stationary unit such as a personal desktop computer or networked terminal within an entity's premises. In some embodiments, the computing system may be a local or remote server which is configured to send and/or receive inputs from other computing systems on the network.

“Channel” as used herein may refer to a source from which an entity may receive authentication data associated with a user. Accordingly, examples of channels may include user applications (e.g., programs, applications, etc.), voice communication lines (e.g., telephone, VoIP), an entity website, physical sites associated with the entity, and the like.

Embodiments of the present invention provide a system, computer program product, and method for cross-channel, continuous, and competitive online authentication of a user. In particular, the system may continuously collect authentication data (e.g., biometric data which may be used to identify a user based on the user's voice, speech, facial features, iris, fingerprint, gait, blood vessels, and the like) each time a user interacts with the entity through one or more of the various channels. In an exemplary embodiment, biometric voice and speech data may be collected from a user each time a user places a telephone call to the entity. Similarly, a biometric data on the user's facial features, fingerprint, and/or iris may be collected each time the user connects to the entity's online systems using an application on a user device (e.g., a mobile application on a user's smartphone). The collected authentication data may be full or partial data (e.g., a sample of voice data may be distorted or short in length); the continuous collection and integration of said data may help ensure that an accurate profile of a user may be constructed even with partial data. In some embodiments, the collected authentication data may comprise non-biometric data, such as behavioral data (e.g., actions taken by the user within the system), transactional data, physiological data about the user, biographical data of the user, content or metadata from applications, device data or metadata of the user, and the like.

In some embodiments, the collected authentication data, which is uniquely associated with a particular user, may be stored in a historical database. In such embodiments, each time authentication data is collected from a user (e.g., active authentication data), said authentication data may be compared to reference data (e.g., historical authentication data). The entity system may then, based on the comparison, calculate a confidence value which indicates the degree of consistency of the active authentication data with the historical authentication data. Accordingly, if the active authentication data is highly consistent (e.g., few or no discrepancies or inconsistencies are detected between the active and historical data), the calculated confidence value may be high. Conversely, if the active authentication data is inconsistent (e.g., multiple or significant discrepancies are detected), the calculated confidence value may be low. For example, a sudden change in the voice or speech of a user may be detected by the entity system as a discrepancy, which may then lower the confidence value. Said confidence value may be calculated each time authentication data is collected from a user, and thus the confidence value may be constantly updated. In other embodiments, the confidence value may be lowered based on other factors of interest to the entity. For instance, the entity may lower the confidence value associated with a particular user if the user's profile has been linked with prior unauthorized activity or if the user is traveling overseas. In some embodiments, the biometric information may be ascertained using an artificial intelligence engine (e.g., a neural network) where despite explicit storage of biometrics data, characteristics and learned profiles are available.

In some embodiments, the system may execute two separate authentication threads in parallel. The first thread may be a traditional authentication thread that may be used in authentication applications (e.g., based on the authentication data, a user is granted or denied access to the system). The second thread may be a competitive or adversarial thread which may be executed in parallel to the traditional authentication thread. The competitive thread may be purely focused on the discrepancies in the authentication thread, and thereby attempt to profile and prove an adversarial strategy. Both processes may be run in parallel in a continuous authentication fashion, where the data from different sessions (e.g., full or partial biometric and other types of data) are collected and used over longer periods of time. In this way, strategic data collection towards hypothesis building and fraud profiling are performed.

In some embodiments, upon detecting that the confidence level has dropped below a specified threshold, the entity system may initiate one or more competitive authentication processes to obtain additional authentication data from the user, who may be identified as a suspected or potential unauthorized and/or malicious user. In some embodiments, the competitive authentication processes may further be triggered by certain suspicious actions, such as an address change, online ID and/or password change, significant account changes, and the like. The competitive authentication processes may, for example, prompt the user to complete one or more predefined (or strategically calculated at run-time) activities (e.g., provide additional authentication data) to further define the user's profile. For instance, the user may be prompted to speak a particular word or phrase, or provide additional information. Based on the additional authentication data collected from the user (e.g., the additional authentication data reveals further discrepancies), the entity system may verify that the user is an unauthorized user and accordingly update the profile of the user to reflect the unauthorized status. In this way, the system continuously collects authentication data to identify suspicious users. In some embodiments, the historical database may comprise a ledger containing profiles of confirmed unauthorized users. The authentication data within said profiles may then be used to positively identify known unauthorized users based on the continuous authentication data collected over time.

Arranging an authentication system in this way addresses a number of technology-centric challenges compared to current technology. In particular, the present invention not only provides access control to the online systems based on the user's authentication data, but also continuously collects authentication data to positively identify trusted or untrusted (e.g., unauthorized or malicious) users, which in turn greatly increases the security of online systems which utilize authentication methods to control user access. Furthermore, invention may, by confirming the identity of potentially malicious users, may mitigate the amount of damage that the malicious users may cause to the online system, which may include data corruption, manipulation, misallocation of computing resources (e.g., processing power, memory space, storage space, cache space, electric power, networking bandwidth, etc.), and the like.

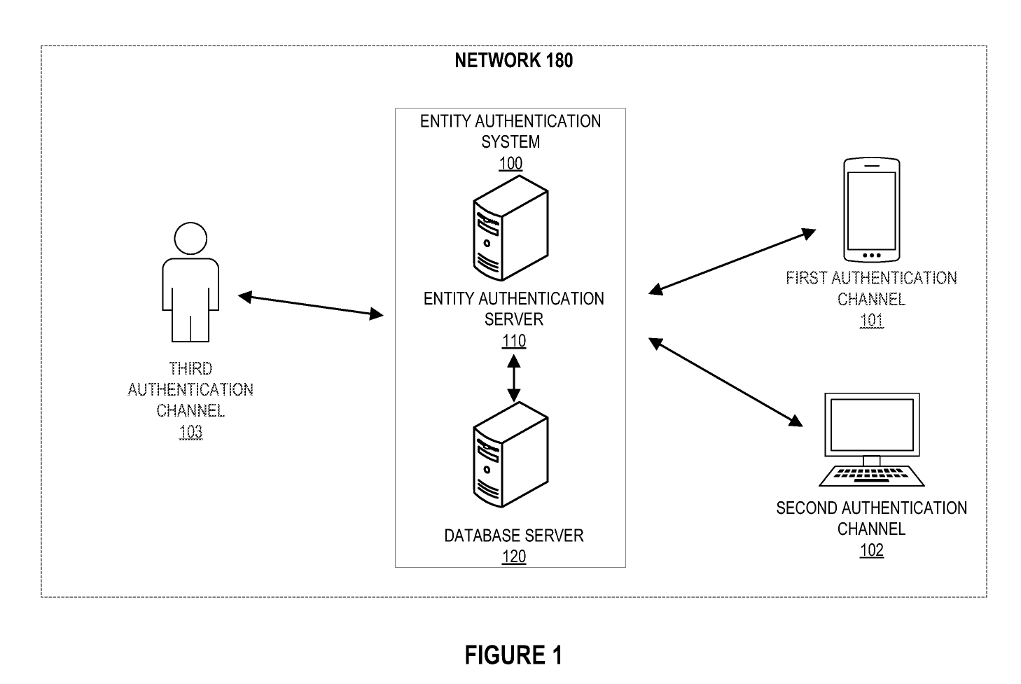

FIG. 1 is a block diagram illustrating an operating environment for the entity authentication system 100, in accordance with one embodiment of the present invention. In particular, the operating environment may include an entity authentication 100, which comprises an entity authentication server 110 and a database server 120, in operative communication with a plurality of authentication channels 101, 102, 103 over a network 180. The network 180 may also be a global area network (GAN), such as the Internet, a wide area network (WAN), a local area network (LAN), or any other type of network or combination of networks. The network 180 may provide for wireline, wireless, or a combination wireline and wireless communication between devices on the network 180. It should be understood by those having ordinary skill in the art that although the entity authentication server 110, the database server 120, the first authentication channel 101, the second authentication channel 102, and the third authentication channel 103 are depicted as single units, each of the depicted computing systems may represent multiple computing systems. In some embodiments, a given computing system as depicted in FIG. 1 may represent multiple systems configured to operate in a distributed fashion. For instance, the entity authentication server 110 may represent a plurality of computing systems which exists within the entity's networks. In other embodiments, the functions of multiple computing systems may be accomplished by a single system. For instance, the functions of the entity authentication server 110 and the database server 120 may, in some embodiments, be executed on a single computing system according to the entity's need to efficiently distribute computing workloads.

Typically, the entity authentication system 100 (including the entity authentication server 110 and the historical database) comprises one or more computing systems within the entity's premises. Said computing systems may be servers, networked terminals, workstations, and the like. The entity authentication server 110 may be configured to receive authentication data from one or more authentication channels 101, 102, 103 on a continuous basis. In some embodiments, the system may comprise a first authentication channel 101 which may be a mobile device such as a smartphone. In such embodiments, the user may use the smartphone to provide authentication data (e.g., biometric voice, speech, fingerprint, or facial data, or other types of data) to the entity authentication server 110. Said authentication data may be provided, for instance, by using the cellular network functions of the smartphone to conduct telephonic communications with the entity authentication server 110. In other embodiments, the authentication data may be provided through a mobile application stored on the smartphone. In some embodiments, said authentication data may be collected each time the user interacts with the entity authentication system 110 through the first authentication channel 101 (e.g., each time the user places a call to the entity or logs onto the entity's systems using the mobile application). In some embodiments, the biometric data collected in a single instance may be partial, incomplete, or subject to interference (e.g., a sample of voice data may comprise interfering background noise). However, because authentication data is collected continuously across multiple channels, the system may integrate the collected authentication data to create a full authentication profile of the user even if the authentication data collected at any single point in time may be incomplete.

In some embodiments, the entity authentication server 110 may receive additional authentication data from a second authentication channel 102, such as a desktop or laptop computer, portable tablet, smart device, and the like. The second authentication channel 102 may also be configured to provide the various types of biometric data described herein. The entity authentication server 110 may be configured to receive authentication data with each interaction the entity authentication server 110 encounters with the second authentication channel 102 (e.g., each time the user logs onto the entity's systems through a software application or web browser).

In some embodiments, the entity authentication server 110 may receive further authentication data from a third authentication channel 103, such as a physical site under the entity's ownership and/or control, such as a branch or office of the entity. In such embodiments, the biometric data may be collected from the user's physical visit to the entity's branch or office. The entity's branch or office may comprise one or more computing systems and/or other devices to collect various types of authentication data, which may include biometric data such as face data, iris data, fingerprint data, gait data, blood vessel data, and the like.

In some embodiments, the entity authentication server 110 may be in operative communication with a database server 120. The database server 120 may comprise storage tables which contain various types of data used by the system in the continuous and competitive authentication process. For instance, the database server 120 may contain reference biometric data associated with users which are collected over time. The database server 120 may further comprise one or more user profiles which comprise various types of information associated with a particular user (e.g., biographical data, biometric data, location data, etc.). Accordingly, biometric data that is continuously collected over time may be associated with a user profile; each user profile may become more complete as biometric data is collected over time. In some embodiments, the user profiles may further comprise user profiles of users suspected or known to be unauthorized and/or malicious. As such, the system may be configured to continue to collect biometric data on suspected unauthorized users until the profiles of said users are “complete.” In some embodiments, the user profiles may be considered “complete” when the system has collected sufficient evidence to establish that a suspected user can be considered a known unauthorized user. In other words, if the system detects that a suspected user's profile is not associated with sufficient evidence (e.g., biometric data) to establish that the suspected user is a known unauthorized user, the system may prompt the user to complete additional authentication steps (e.g., speak a certain word or phrase, provide fingerprint/iris/facial data, provide a PIN or password, etc.). In such embodiments, the database server 120 may further comprise pattern data which indicates that certain actions or patterns of actions taken by a user may be classified as suspicious or malicious.

In some embodiments, the database server 120 may further store confidence levels associated with each user profile, where the confidence levels indicate the level of certainty with which the system has identified a particular user. Typically, the confidence levels are constantly being adjusted upwards or downwards based on the level of match (or mismatch) of acquired biometric data with the historical data; if the acquired biometric data is consistent with the historical data, the confidence levels may be adjusted upward. Conversely, if the acquired biometric data is inconsistent with the historical data (e.g., a mismatch vector has been detected), then the confidence level may be adjusted downward. Once the confidence level has dropped below a particular threshold, the system may take a number of remedial actions to either eliminate or confirm the mismatch.

In some embodiments, the database server 120 may further comprise a storage table with pattern data regarding various patterns. For instance, the patterns may relate to strategies to take corrective actions in response to detecting an unauthorized user, such as restricting access or by calculating mismatch vectors and deciding to continue collecting biometric or behavior data from the user. The pattern data may, in some embodiments, include known patterns of unauthorized access or malicious actions, which the system may use to more readily recognize said patterns to help prevent damage to the entity and entity's systems. In other embodiments, the pattern data may include internal entity policies which are relevant to particular scenarios.

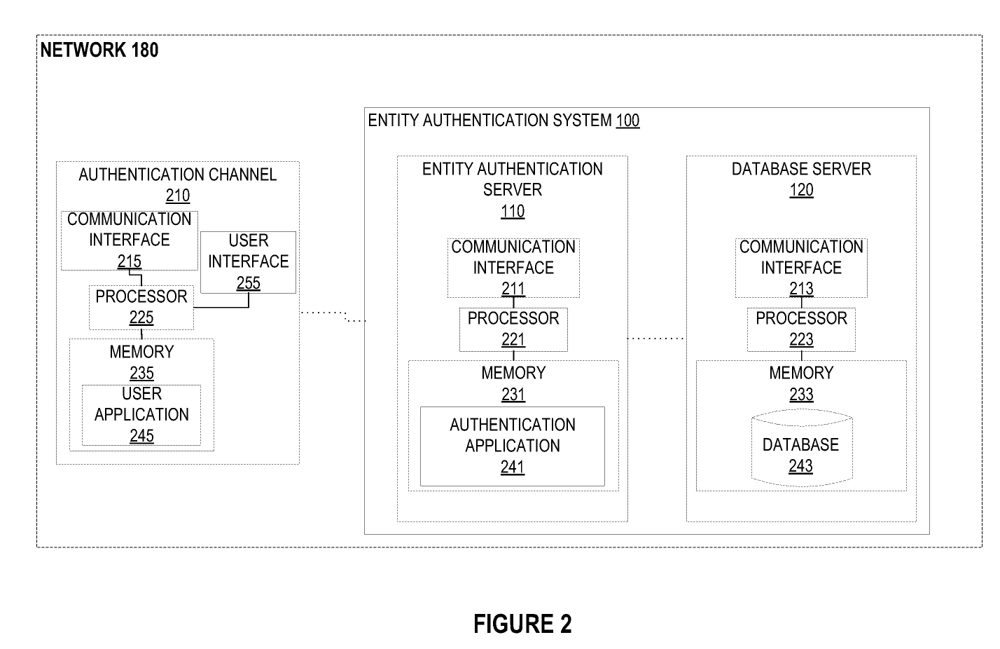

FIG. 2 is a block diagram illustrating the entity authentication server 110, the database server 120, and an authentication channel 210 in more detail, in accordance with one embodiment of the present invention. The entity authentication server 110 typically contains a processor 221 communicably coupled to such devices as a communication interface 211 and a memory 231. The processor 221, and other processors described herein, typically includes circuitry for implementing communication and/or logic functions of the entity authentication server 110. For example, the processor 221 may include a digital signal processor device, a microprocessor device, and various analog to digital converters, digital to analog converters, and/or other support circuits. The entity authentication server 110 may use the communication interface 211 to communicate with other devices over the network 180. The communication interface 211 as used herein may include an Ethernet interface, an antenna coupled to a transceiver configured to operate on a cellular data, GPS, or WiFi signal, and/or a near field communication (“NFC”) interface. In some embodiments, a processing device, memory, and communication device may be components of a controller, where the controller executes one or more functions based on the code stored within the memory.

The entity authentication server 110 may include a memory 231 operatively coupled to the processor 221. As used herein, memory includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

The memory 231 within the entity authentication server 110 may have an authentication application 241 stored thereon, where the authentication application 241 may comprise the code and/or logic to execute the cross-channel continuous and competitive authentication methods. Accordingly, the authentication application 241 may cause the components of the entity authentication server 110 to accept authentication data from the one or more authentication channels 210, calculate confidence levels and/or mismatch vectors using the data within the database server 120, integrate full or partial biometric data to create a profile of a user, and so on. In other embodiments, the processes of the entity authentication server 110 may be executed in a decentralized manner across a plurality of external devices (e.g., mobile or portable devices) with limited interconnectivity with back-end data centers and/or servers.

The authentication channel 210 may represent the one or more computing devices through which biometric data is collected by the entity authentication server 110. Thus, it should be understood that although the authentication channel 210 is represented as a single unit, it is within the scope of the invention for the entity authentication server 110 to be in operative communication with multiple authentication channels 210. The authentication channel 210 may, in some embodiments, be a portable device such as a smartphone, smart device, tablet, internet-of-things device, or the like. In other embodiments, the authentication channel 210 may represent a stationary computing system such as a desktop computer, networked terminal, or the like. The authentication channel 210 comprise a communication interface 215, a processor 225, and a memory 235 having a user application 245 stored thereon. The user application 245 may comprise logic and/or code to allow a user to connect to the entity's systems and/or provide authentication data (e.g., biometric data) to the entity authentication server 110. For instance, the user application 245 may be an application on a smartphone which allows the user to initiate a voice communication session with the entity. Alternatively, the user application 245 may be an entity-provided application (e.g., mobile app) or third-party application (e.g., web browser) which allows the user to connect to the entity authentication server 110 through the authentication channel 210.

The processor 225 may further be in operative communication with a user interface 255, where the user interface 255 may comprise the hardware and software implements to accept input from and provide output to the user. Accordingly, the user interface 255 may comprise hardware such as a display, audio output devices, projectors, and the like, or input devices such as keyboards, mice, sensors, cameras, microphones, biometric input devices (e.g., fingerprint readers), and the like. The user interface 255 may further comprise software such as a graphical or command-line interface through which the user may provide inputs and/or receive outputs from the entity computing system 150. It should be understood that the display on which the user interface 255 is presented may include an integrated display (e.g. a tablet or smartphone screen) within the entity computing system 150, or an external display device (e.g. a computer monitor or television). The user interface 255 may be configured to collect various types of authentication data (e.g., biometric data) from the user, including data collected from the user's voice (e.g., pitch, amplitude, etc.), speech (e.g., cadence, diction, word choice, etc.), face (e.g., facial recognition from a captured image), iris, fingerprint, gait (e.g., cadence, speed, etc.), blood vessels (e.g., veins in the palm, finger, eye, etc.), and the like.

The database server 120 may comprise a communication interface 213, a processor 223, and a memory 233. The memory 233 may comprise a database 243 which comprises historical biometric data associated with one or more users. Typically, as the entity authentication server 110 collects biometric data over time, said biometric data may be stored within the database 243 of the database server 120. In some embodiments, the database 243 may further comprise one or more user profiles, where each user profile may be associated with a particular user. Each user profile may further be associated with one or more samples of biometric data. In this way, each user profile may comprise a body of reference biometric data against which streaming biometric data (e.g., current biometric data) may be compared in order to detect consistency and/or anomalies. The user profiles may comprise one or more known unauthorized users, such that the system may match biometric data obtained from a user with a profile associated with a known unauthorized user to determine that a particular user is an unauthorized user.

In some embodiments, the database 243 may further comprise confidence levels associated with each user. The confidence level typically represents the degree of certainty to which a particular user logging onto the system has been identified. The confidence level may be increased or decreased based on determining whether streaming user biometric data (e.g., biometric data being collected in real time for a particular user) is consistent with the historical data associated with the user and/or the user profile. For example, if the user profile and historical data associated with a first user indicate that the first user is a female, the system will detect an inconsistency if a user purporting to be the first user provides biometric data (e.g., voice data) which indicates that the user is male. In response to detecting the inconsistency, the system may reduce the confidence level associated with the first user. If said confidence level falls below a certain threshold, the system may initiate the competitive authentication process (e.g., the user is now a suspected unauthorized user for the purposes of the system), through which the system may attempt to gather additional biometric data from the suspected unauthorized user to confirm or eliminate the mismatch. For instance, the system may prompt the suspected user to provide an additional biometric data sample (e.g., an additional voice sample, fingerprint sample, facial data sample, etc.). Based on the consistency (or inconsistency) of the additional voice sample with the first user profile and/or the historical data associated with the first user, the system may confirm that the suspected user is an unauthorized user if the additional biometric data is inconsistent with the user profile and/or historical data. On the other hand, the system may eliminate the mismatch (e.g., the user's illness caused her voice to change) if the additional biometric data is consistent with the user's profile and/or historical data.

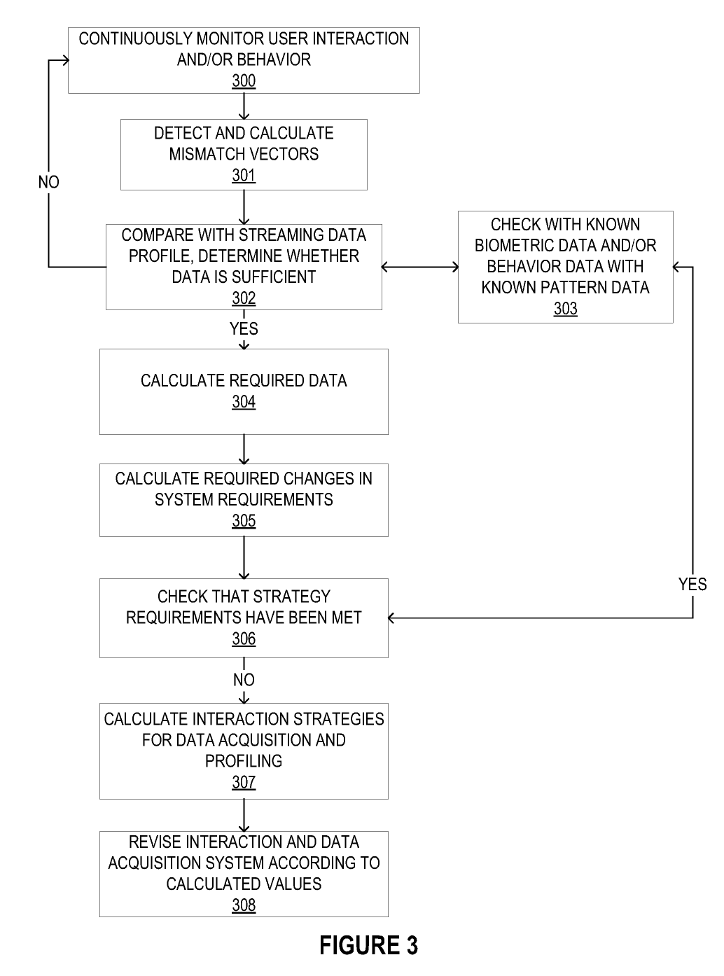

FIG. 3 is a process flow illustrating an application of the continuous and competitive online authentication process, in accordance with one embodiment of the present invention. The process begins at block 300, where the system continuously monitors user interaction and/or behavior. The system may continuously receive authentication data and/or behavior data from a user. At this stage, the system is continuously monitoring the activity and/or behavior of each user based on each interaction that the user has with the entity system. Said interactions may take place through various channels and may include, for instance, voice communications with the entity, online communications via an app or website, physical visits to branch locations of the entity, and the like. Typically, with each interaction, the entity collects authentication data (e.g., biometric data) from the user. In some embodiments, the types of biometric data collected may depend on the channel through which the biometric data is collected. For instance, voice or speech biometric data may be collected during voice communications with the user, while facial or iris biometric data may be collected through a mobile application, and gait or posture biometric data may be collected during a user's physical visit to an entity's location. Each sample of biometric data may be stored in the historical database and/or associated with a user profile. The behavior data collected by the system may comprise certain actions taken by the user, such as accessing a certain part of the entity application or website, accessing certain menu options during a voice communication session, or speaking certain words or phrases during a voice communication session. In this way, the system continuously collects biometric data and/or behavior data from multiple channels to confirm the identity of its users.

The process continues to block 301, where the system detects and calculates mismatch vectors. At this stage, the system may have detected an inconsistency or anomaly in the streaming (i.e., current) biometric data based on a comparison with historical data and/or the user profile. The system may calculate one or more mismatch vectors which indicate the degree (e.g., quantitative level of divergence) of inconsistency of the streaming biometric data with historical biometric data as well as other profile data for consistency checks. In other embodiments, this step may be executed without any detection of inconsistency or anomaly (e.g., the step may be executed based on threat profiles and/or policies). For instance, if the historical data and user profile indicate that the user is female, but the streaming biometric data is indicative of a male voice, the system may calculate a mismatch vector which represents the degree of divergence from expected values based on historical data and/or the user profile. The mismatch vector may then be used to adjust the confidence level associated with authentication said user. If the confidence level drops below a certain level, the system may initiate the competitive authentication process; typically, at this stage, the user causing the mismatch will be considered by the system to be a suspected unauthorized user until the mismatch has been confirmed or eliminated. In some embodiments, the system may not immediately prevent the suspected user from continuing to access the system. In this way, the system may continue to collect evidence (e.g., authentication and other data) from the suspected user to confirm or eliminate the mismatch.

The process continues to block 302, where the system compares the calculated mismatch vectors with a streaming data profile and determines whether the data possessed by the system is sufficient. At this step, the system may determine whether additional authentication data is required. In some embodiments, the system may determine that the biometric data collected from the suspected user is sufficient to confirm or eliminate the mismatch. For instance, the system may consider the biometric data to be sufficient if the system is able to positively identify the user as an unauthorized user, such as by matching the streaming biometric data with the historical data and/or user profile associated with a known unauthorized user. In some embodiments, the system may be able to eliminate the mismatch by identifying the mismatch as a temporary anomaly, such as a temporary change in voice due to an illness of the user. In such embodiments, the process may proceed to block 300, where the system continues to receive authentication data from users across multiple channels. The system continuously self-adjusts to achieve consistency across different data acquisition channels, devices, times, etc.

However, the system may determine that the biometric data is insufficient. For instance, if the biometric data is a voice sample, the voice sample may be distorted due to connectivity issues, or the sample may not be recorded in sufficient detail (e.g., bitrate) to capture the data needed to compare the streaming biometric data against the historical data. In such embodiments, the system may determine that additional authentication data is required, and subsequently proceed to block 304, where the system calculates the required data (e.g., determines system requirements for additional authentication data). Said system requirements may be related to data quality (e.g., image/video resolution, audio bitrate and/or range, etc.), particular data segments (e.g., upper face biometrics, keywords in voice biometrics), or other data requirements. In some embodiments, the system requirements may include non-authentication data, such as the identity of the device (e.g., device specs, hardware ID, operating system, etc.), location of the device (as determined by GPS, IP address, NFC, Wi-Fi, etc.), digital signatures, application profiling data, physiological data, application content data, other user interactive data, and the like. In some embodiments, the system may further proceed to block 303, where the system compares biometric data and/or behavior data with known pattern data. In particular, the system may access pattern data within the historical database which is associated with actions or patterns of actions which are known by the system to be unauthorized. For instance, the known pattern data may include a set of actions which are associated with a web exploit, or may include certain key phrases or questions which are associated with unauthorized or malicious behavior.

The process continues to block 305, where the system calculates the required changes in system requirements. The system may implement changes in system requirements based on determining the system requirements for additional authentication data. In particular, the system may update various data requirements for obtaining additional authentication data. For instance, if the system's current data requirements include a requirement that audio data obtained from a user should be a minimum of 128 kbps, and the system has determined that a higher bitrate is required, the system may update said data requirements such that audio data obtained from a user should be a minimum of 192 kbps.

The process continues to block 306, where the system checks that strategy requirements have been met, or verifies that strategy requirements have been satisfied. Typically, said strategy requirements may include strategies or patterns for interacting with and/or profiling the user, which may include obtaining additional and/or different types of authentication data from the user. For instance, if a voice sample indicating a mismatch is provided by a suspected user, and the voice sample is not sufficient (e.g., distorted, too short, of insufficient audio quality/fidelity) to confirm or eliminate the mismatch, the strategy requirements may include requiring the suspected user to provide additional voice samples, which may include requiring the suspected user to speak a certain word or phrase. In some embodiments, the strategy requirements may further include requiring the user to provide different authentication data, and may further require that the user provides said authentication data through different channels (e.g., interaction with intelligent engines, answer questions, provide additional information, etc.). Referring again to the example in which the voice sample provided by a suspected user is insufficient, the system may require that the user provides a fingerprint sample, facial, iris or other authentication data through a mobile device. If the strategy requirements have been satisfied, the system may proceed to block 303 and compare the biometric data and/or behavior data with known pattern data.

If the strategy requirements have not been satisfied, the process may continue to block 307, where the system calculates interaction strategies for data acquisition and profiling. In particular, the system may revise strategies for interacting with the suspected user to obtain the biometric data needed to positively identify the user. For instance, the strategy requirements may be revised to require the suspected user to take additional actions, such as provide additional voice samples, answer particular questions, provide additional biometric data through other channels, and the like. In some embodiments, the system may quarantine a suspected user (e.g., a sandbox) to allow the suspected user to take various actions within the system. In this way, the system may be able to continue to collect authentication data and/or behavior data without the risk of the suspected user taking malicious actions to damage the system.

Finally, the process concludes at block 308, where the system revises interaction and data acquisition system according to calculated values. At this step, the system may implement changes in strategy requirements. Typically, implementing said changes involves updating the strategy requirements within the historical database to reflect the revised strategies as calculated by the system. In this way, the system may be able to constantly optimize interaction strategies for different types of suspected users and/or different types of user patterns such that over time, the system becomes increasingly efficient at collecting biometric evidence and at identifying unauthorized or malicious users.

In some embodiments, the system may execute authentication streams in parallel. For instance, the system may execute a first authentication stream which determines whether to authenticate the user and provide or deny access to the system. In parallel, the system may execute a second authentication stream which determines whether to continue to collect biometric data for a particular user. In this way, the system goes beyond merely authenticating the user; the system also continuously collects biometric data in a competitive or adversarial fashion to gather sufficient evidence to positively identify unauthorized users.

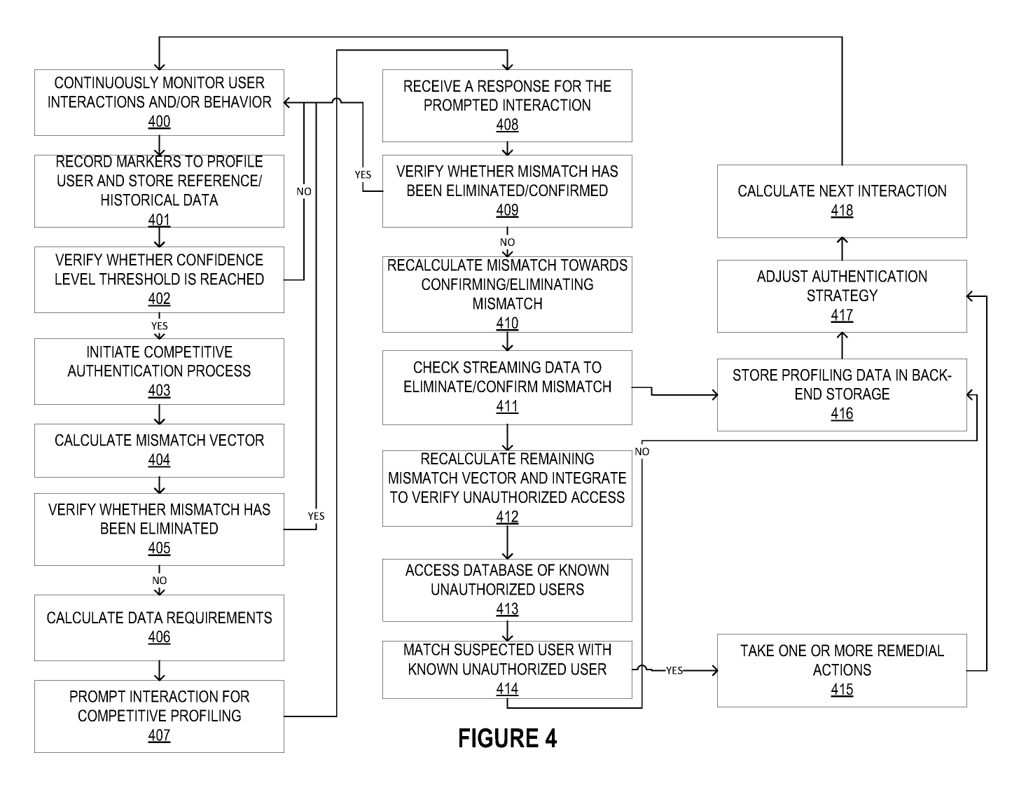

FIG. 4 is a process flow for calculating mismatch vectors to verify unauthorized access, in accordance with one embodiment of the present invention. The process begins at block 400, where the system continuously monitors user interactions and/or behavior. Typically, the system is configured to monitor the actions and behavior of each user within the system on a constant, real-time basis. Accordingly, the system continues to collect various types of data (e.g., biometric data, behavior data, device metadata, and other types of non-biometric data) and store said data as reference data in the historical database.

The process continues to block 401, where the system records markers to profile the user and store reference and/or historical data. The system may receive authentication data, such as biometric and behavior data from a user. Typically, biometric data and behavior data are collected from the user with each interaction that a user has with the entity's system. The biometric data may be collected through one or more different channels on a consistent basis.

The process continues to block 402, where the system verifies whether a confidence level threshold is reached. As described above, a confidence level may be associated with each user profile, where the confidence level represents the level of certainty with which the system has positively identified the user. Typically, the system recalculates the confidence level and adjusts it upward or downward depending on the biometric data collected from the user over time. Accordingly, users providing authentication data consistent with reference data over a long period of time will have a relatively high confidence level associated with the user's profile, and conversely, user profiles for which inconsistent authentication data is frequently provided will have a relatively lower confidence level. If the confidence level does not fall below a specified threshold, the process may loop back to block 400.

If the confidence level falls below a specified threshold, the process may proceed to block 403, where the system initiates the competitive authentication process. In some embodiments, the confidence level may be lowered threshold based on certain circumstances, such as if the user profile has been associated with multiple unauthorized or malicious attempts to access the system, or if the user associated with the user profile is currently traveling and unreachable. Accordingly, under certain circumstances, a particular user profile may be associated with a lower confidence level (or a higher threat score, e.g., phi shing attacks for key contacts in organizations due to their roles) by default, and thus the system may be more sensitive to biometric data mismatches with reference data under such circumstances. Once the competitive authentication process has been initiated, the user will be considered by the system to be a suspected unauthorized user until the mismatch has been either eliminated (e.g., the mismatch is considered to be within acceptable boundaries) or confirmed (e.g., the suspected user will be considered a known unauthorized user).

The process continues to block 404, where the system calculates a mismatch vector based on the authentication data (e.g., biometric data and/or non-biometric data, such as behavior data). The mismatch vector may represent the degree of deviation from historic and/or reference data (e.g., biometric, profile, or location data). Typically, a mismatch vector may be calculated for each authentication data sample obtained from the user. Accordingly, the system may be configured to resolve multiple mismatch vectors representing biometric data taken at different times from different channels.

The process continues to block 405, where the system verifies whether a mismatch associated with the mismatch vector has been eliminated or confirmed. Typically, this step involves comparing the streaming biometric data with the historical or reference data associated with a particular user profile within the historical database. The historical/reference data may comprise previously collected biometric data and/or non-biometric data, such as user profile data, location data, device metadata, threat profile data, historical attack profiles, and the like. If the biometric data collected is considered to be consistent with the reference data, then the mismatch will be considered to have been eliminated. In some embodiments, such a determination may involve the system determining that the biometric data falls within a certain expected range. For instance, if the reference biometric data indicates that the voice data for a particular user has an average fundamental frequency of 200 Hz, the average fundamental frequency for a streaming voice biometric data sample may be compared with that of the reference data to ensure that the value falls within an expected range (e.g., within 10 Hz of 200 Hz). If the mismatch is considered to have been eliminated, the process may loop back to block 400.

If the mismatch has not been eliminated, the process may proceed to block 406, where the system calculates one or more data requirements to eliminate or confirm the mismatch. As described above, said data requirements may involve data quality or fidelity requirements (e.g., resolution, bitrate, etc.) and/or sample size requirements (e.g., lengthier samples or a greater number of samples). Calculating said data requirements helps the system to determine the interactive steps that it should take with respect to the suspected user to obtain the data needed to eliminate or confirm the mismatch.

The process proceeds to block 407, where the system prompts the suspected user for interaction based on the data requirements, for competitive profiling purposes. The prompting the user typically comprises a request for the user to complete a certain action or activity, such that the system may collect additional biometric data to eliminate or confirm the mismatch. For instance, may request that the user speak a certain word or phrase to receive additional voice and/or speech biometric data. In other embodiments, the system may request other types of biometric data, such as fingerprint, iris, face biometrics, typing input, movement profiles, and other behavioral biometrics as well as non-biometric data.

The process continues to block 408, where the system receives a response for the prompted interaction. Typically, the response comprises the additional authentication data requested by the system.

The process continues to block 409, where the system verifies whether the mismatch has been eliminated or confirmed based on the additional authentication data. The system may compare the additional authentication data with the historical and/or reference data to determine whether the mismatch has been eliminated (e.g., the inconsistencies in the authentication data are within acceptable limits) or confirmed (e.g., the suspected user is confirmed to be an unauthorized user). If the mismatch is eliminated or confirmed, the process may loop back to block 400.

If the mismatch still has not been eliminated or confirmed, the process may continue to block 410, where the system recalculates the mismatch towards confirming or eliminating the mismatch. In some embodiments, the system may recalculate using the remaining mismatch vectors. After recalculating all remaining mismatch vectors, the process may continue to block 411, where the system checks the streaming data to eliminate or confirm the mismatch.

The process may continue to block 412, where the system recalculates the remaining mismatch vector and integrates the vectors to verify unauthorized access. Based on the integration of the mismatch vectors, the system may determine that the suspected user is an unauthorized user. Upon detecting that the suspected user is an unauthorized user, the process may continue to block 415, where the system stores a user profile of the unauthorized user in a back-end storage. Said back-end storage may be a particular database within the database server, such as a database of known unauthorized users.

In some embodiments, the process may continue to block 413, where the system accesses a database of known unauthorized users. Typically, said database is stored within the database server as seen in FIG. 1 and FIG. 2. The may contain user profiles of users who have been identified as unauthorized users in the past, where the user profiles may further comprise biometric and/or biographical data about the unauthorized user. Said user profiles may then be used to efficiently make a positive identification of unauthorized users in the future.

The process may then continue to block 414, where the system matches the suspected user with a user profile of a known unauthorized user. At this step, the system may compare the biometric data and additional biometric data provided by the suspected user with the historical and/or reference data associated with the user profile of the known unauthorized user to confirm a match. The biometric data and additional biometric data of the suspected user may then be associated with the user profile of the known unauthorized user. By continuously collecting data on known unauthorized users, the system may be able to more efficiently and quickly identify known unauthorized users in the future.

The process may then continue to block 415, where the system takes one or more remedial actions in response to matching the suspected user with a known unauthorized user. For instance, a remedial action may comprise preventing the known unauthorized user from continuing to access the system. Another remedial action may be to generate a log of the actions attempted by the known unauthorized user.

The process concludes at block 417, where the system may adjust an authentication strategy based on the one or more remedial actions. For instance, the system may recalculate a user's confidence level to influence future interactions of the user with the system. To illustrate, a user whose user profile has been associated with unauthorized access attempts may be associated with a lower confidence level, such that the system may more quickly identify said unauthorized access attempts with greater reliability and efficiency in the future.

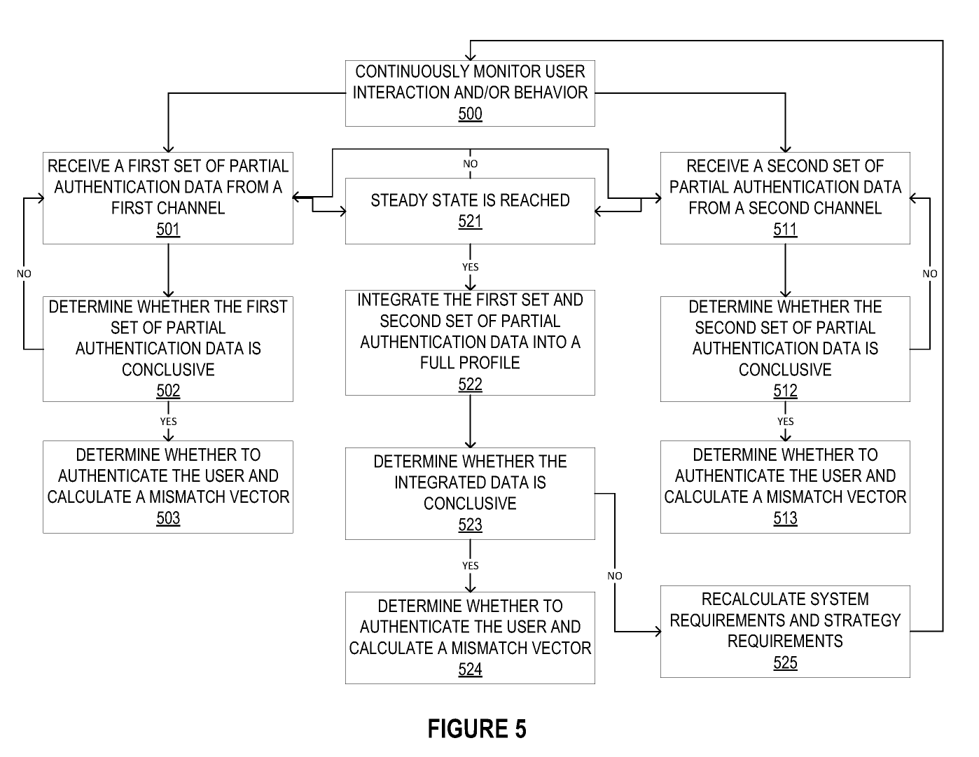

FIG. 5 illustrates a process flow for a multi-channel and continuous authentication method, in accordance with one embodiment of the present invention. The process begins at block 500, where the system continuously monitors user interaction and/or behavior.

The process continues to block 501 and block 511, where the system, in parallel, receives a first set of partial authentication data from a first channel and receives a second set of partial authentication data from a second channel. Typically, the first set of partial authentication data and second set of partial authentication data are provided by the same user. Both sets of partial authentication data may be of the same type in some embodiments (e.g., two voice samples), or in other embodiments may be different (e.g., a voice sample and a fingerprint sample).

The process continues, in parallel, to block 502 and block 512, where the system determines whether the first set of partial authentication data is conclusive and determines whether the second set of partial authentication data is conclusive. Determining whether a particular set of partial authentication data is conclusive may comprise detecting whether there is a mismatch between the partial authentication data and the reference data associated with the user, and/or determining whether the partial authentication data is sufficient to conclusively eliminate or confirm said mismatch. If the partial authentication data is not conclusive, the process may loop back to block 501 and block 511 in parallel.

If the partial authentication data is conclusive, the process may proceed to block 503 and block 513 in parallel, where the system determines whether to authenticate the user and calculate a mismatch vector. In some embodiments, the system may determine that the partial authentication data has not produced a mismatch (e.g., the user is who the user claims to be) and thereby grant access to the system. In other embodiments, the system may determine that the user is a suspected or known unauthorized user, as indicated by the mismatch in the partial authentication data. In such embodiments, the system may elect to continue to provide access to the system while collecting additional authentication data from the suspected user, as described above. The system may further calculate a mismatch vector to confirm the identity of the suspected unauthorized user. In some embodiments, such as if the user has been matched with the profile of a known unauthorized user, the system may restrict the user from continuing to access the system.

In some embodiments, the process may proceed from block 501 and 511 to block 521, where the system determines whether a steady state has been reached. Typically, a steady state is reached when the necessary partial authentication data from the first channel and the second channel have been collected, and the system has stopped collecting said partial authentication data. If the system has not reached a steady state, the system may loop back to block 501 and/or block 511 to collect additional partial authentication data as needed.

If the steady state has been reached, the process may continue to block 522, where the system integrates the first set and the second set of partial authentication data (e.g., partial biometrics or other limited data) into a full profile associated with the user. The profile associated with the user may comprise the streaming (e.g., current) partial authentication data collected by the system as well as historical or reference data (including biometric and non-biometric data). Accordingly, the profile associated with the user may provide the system with a more complete set of data from which to eliminate or confirm mismatches.

The process continues to block 523, where the system determines whether the integrated data (e.g., the profile) is conclusive. Typically, determining whether the profile is conclusive comprises comparing the streaming authentication data with the data within the user profile to determine whether a mismatch may be eliminated or confirmed. For instance, if the partial authentication data has a mismatch that falls within acceptable limits, the system may, by taking into account the entire user profile, determine that the mismatch has been eliminated. Conversely, if the mismatch falls outside of acceptable limits and the system has been able to confirm the mismatch (e.g., confirm that a suspected user is an unauthorized user), the system may also consider the profile to be conclusive. If the profile is not conclusive (e.g., the mismatch falls outside of acceptable limits and there is not enough evidence to eliminate the mismatch), the system may proceed to block 525, where the system recalculates system requirements and strategy requirements to obtain additional authentication data (or other types of data) to resolve the mismatch, as described above. In another embodiment, all the parameters for mismatch and thresholds may just be handled by a separate learning engine without specifying thresholds and other limits (such as a neural network based engine).

If the profile is conclusive, the process concludes at block 524, where the system determines whether to authenticate the user and calculate a mismatch vector.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for continuous and competitive authentication, comprising:
a processor;
a communication interface; and
a memory having executable code stored therein, wherein the executable code, when executed by the processor, causes the processor to:
detect that a confidence level associated with a user has dropped below a specified threshold; and
continuously execute a first authentication thread in parallel to a second authentication thread, wherein the first authentication thread is a competitive authentication thread.

2. The system according to claim 1, wherein the executable code, when executed by the processor, causes the processor to:
continuously maintain a profile associated with the user;
strategically decide on actions to authenticate the user or collect evidence of unauthorized access by the user, wherein the actions comprises acquiring data from each interaction with the user; and
integrate the data acquired from each interaction with the user.

3. The system according to claim 2, wherein acquiring data from each interaction with the user is accomplished using a data acquisition pattern, wherein the data acquisition pattern is continuously updated based on the confidence level associated with the user.

4. The system according to claim 2, wherein the executable code, when executed by the processor, causes the processor to:
calculate a mismatch vector associated with a mismatch by comparing the data acquired from each interaction with the user with reference profile data; and
use the mismatch vector to confirm or eliminate the mismatch.

5. The system according to claim 3, wherein the data acquisition pattern comprises prompting the user to take one or more user actions.

6. The system according to claim 5, wherein the prompting the user to take one or more user actions comprises one of prompting the user to provide biometric data, answer a question, provide additional authentication information, and provide device or location data.

7. The system according to claim 2, wherein integrating the data acquired from each interaction with the user comprises creating an unauthorized user profile, wherein the executable code, when executed by the processor, causes the processor to cross check data acquired from each interaction with the user with one or more known unauthorized user profiles.

8. The system according to claim 1, wherein the executable code, when executed by the processor, causes the processor to:
receive a first set of authentication data from the user through a first channel;
detect that a confidence level associated with the user has dropped below a specified threshold;
initiate a competitive authentication process;
determine, based on a first mismatch vector, whether a first set of additional authentication data is required;
determine system requirements for the first set of additional authentication data;
determine strategy requirements for the first set of additional authentication data; and
implement the system requirements and the strategy requirements for the first set of additional authentication data.

9. The system according to claim 8, wherein the executable code further causes the processor to:
receive a second set of authentication data from the user through a second channel;
determine, based on a second mismatch vector, whether a second set of additional authentication data is required;
determine system requirements for the second set of additional authentication data;
determine strategy requirements for the second set of additional authentication data; and
implement the system requirements and the strategy requirements for the second set of additional authentication data.

10. The system according to claim 8, wherein the executable code further causes the processor to:
continuously receive data associated with the user; and
update a user profile associated with the user to include the data associated with the user.

11. The system according to claim 9, wherein the executable code further causes the processor to:
prompt the user for the first set of additional authentication data;
receive the first set of additional authentication data from the user;
compare the first set of additional authentication data with a user profile associated with the user; and
determine, based on the first set of additional authentication data and the user profile associated with the user, that the user is an unauthorized user.

12. The system according to claim 11, wherein determining that the user is an unauthorized user comprises:
comparing the first set of additional authentication data with a user profile associated with a known unauthorized user; and
determining a match between the first set of additional authentication data with the user profile associated with the known unauthorized user.

13. The system according to claim 9, wherein the executable code further causes the processor to:
detect that a steady state has been reached for the first channel and the second channel;
integrate the first set of authentication data and the second set of authentication data into a profile associated with the user; and
determine, based on the profile associated with the user, whether a third set of additional authentication data is required.

14. A controller for continuous and competitive authentication, comprising a communication device, a processor, and a memory having executable code stored therein, wherein the executable code, when executed by the processor, causes the processor to:
detect that a confidence level associated with a user has dropped below a specified threshold; and
continuously execute a first authentication thread in parallel to a second authentication thread, wherein the first authentication thread is a competitive authentication thread.

15. The controller according to claim 14, wherein the executable code, when executed by the processor, causes the processor to:
continuously maintain a profile associated with the user;
strategically decide on actions to authenticate the user or collect evidence of unauthorized access by the user, wherein the actions comprises acquiring data from each interaction with the user; and
integrate the data acquired from each interaction with the user.

16. The controller according claim 15, wherein the executable code, when executed by the processor, causes the processor to:
calculate a mismatch vector associated with a mismatch by comparing the data acquired from each interaction with the user with reference profile data; and
use the mismatch vector to confirm or eliminate the mismatch.

17. The controller according to claim 14, wherein the executable code, when executed by the processor, causes the processor to:
receive a first set of authentication data from the user through a first channel;
detect that a confidence level associated with the user has dropped below a specified threshold;
initiate a competitive authentication process;
determine, based on a first mismatch vector, whether a first set of additional authentication data is required;
determine system requirements for the first set of additional authentication data;
determine strategy requirements for the first set of additional authentication data; and
implement the system requirements and the strategy requirements for the first set of additional authentication data.

18. A computer-implemented method for continuous and competitive authentication, the method comprising:
detecting that a confidence level associated with a user has dropped below a specified threshold; and
continuously executing a first authentication thread in parallel to a second authentication thread, wherein the first authentication thread is a competitive authentication thread.

19. The computer-implemented method of claim 18, further comprising:
continuously maintaining a profile associated with the user;
strategically deciding on actions to authenticate the user or collect evidence of unauthorized access by the user, wherein the actions comprises acquiring data from each interaction with the user; and
integrating the data acquired from each interaction with the user.

20. The computer-implemented method of claim 18, further comprising:
receiving a first set of authentication data from a user through a first channel, wherein the authentication data comprises biometric data;
detecting that a confidence level associated with the user has dropped below a specified threshold;
initiating a competitive authentication process;
determining, based on a first mismatch vector, whether a first set of additional authentication data is required;
determining system requirements for the first set of additional authentication data;
determining strategy requirements for the first set of additional authentication data; and
implementing the system requirements and the strategy requirements for the first set of additional authentication data.
